(19) United States
(12) Patent Application Publication
(10) Pub. No.: US 2014/0092867 A1
(43) Pub. Date: Apr. 3, 2014

(54) METHOD AND SYSTEM FOR REDIRECTION BETWEEN DISPARATE SYSTEMS

(71) Applicants: Yuanfang Yu, Shenzhen (CN); Ting Lu, Shenzhen (CN); Yonggang Fang, Shenzhen (CN); Xiaowu Zhao, Shenzhen (CN)

(72) Inventors: Yuanfang Yu, Shenzhen (CN); Ting Lu, Shenzhen (CN); Yonggang Fang, Shenzhen (CN); Xiaowu Zhao, Shenzhen (CN)

(73) Assignee: ZTE CORPORATION, Shenzhen, GD (CN)

(21) Appl. No.: 14/008,613

(22) PCT Filed: Jan. 18, 2012
(86) PCT No.: PCT/CN2012/070536

§ 371 Date: Sep. 30, 2013

(30) Foreign Application Priority Data
Mar. 29, 2011 (CN) 20110077322.2

(51) Int. Cl. H04W 36/00

(52) U.S. Cl. CPC H04W 36/0066
USPC 370/331

(57) ABSTRACT

Disclosed are a method and a system for inter-system redirection. The method comprises: a base station sending a first message to a terminal, instructing the terminal to perform redirection; and the terminal accessing the redirected network; wherein the first message carries at least one of the following: a type of wireless access technology, an identifier of whether to redirect, threshold information of redirection, recognition information of the redirected cell, carrier frequency information, return indication of redirection failure, and grouping information of redirection. The present invention solves the problem in the related art of mobile terminal in a HRPD network performing completely autonomous reselection between different systems, thus reducing the network load, lowering network operating costs, and ensuring to the greatest extent the quality of service for users.

### FIELD

The present invention relates to the field of communications, and particularly, to a method and a system for inter-system redirection.

### BACKGROUND

Currently, the interoperation among the subsequent evolved networks of code division multiple access (CDMA) and the networks of other wireless access technologies, especially the long term evolution (LTE) networks is a development trend of wireless communications. However, it would be a complicated replacement process for evolving from the already commercialized CDMA network to the LTE network, and during this replacement process, there will be a very long coexistence period, during which coexistence period, these two kinds of wireless networks will interconnect and intercommunicate.

Taking a CDMA high speed packet data (HRPD) system for example, for a mobile terminal in the HRPD network, especially a mobile terminal in the overlapped area with LTE network, the HRPD network shall provide a certain mechanism to instruct the terminal to access an adjacent LTE network by means of network reselection. Basically, the HRPD network shall send to the terminal configured inter-system neighbor information via a common overhead channel or a dedicated service channel, and after the information is received by the terminal, the terminal can perform inter-system pilot measurement autonomously and decide whether to handover to an adjacent different system autonomously according to the control information such as threshold or priority and so on in the neighbor information.

However, the above-mentioned solution cannot meet the demand of HRPD network completely. Here, taking HRPD and LTE for example to describe this, it shall be noted that the problem mentioned here can also be suitable for the situation where the HRPD interoperates with other wireless access technologies. FIG. 1 is a schematic diagram of a network at the initial stage of LTE network deployment according to the related art, and as shown in FIG. 1, at the initial stage of LTE network deployment, the HRPD network is of whole network coverage, LTE makes local hotspot coverage, and both the signal strength and signal quality of the HRPD network are always good, and in such a situation, depending on the autonomous measurement and reselection mechanism of the terminal, the terminal might always select the HRPD network, which will cause a low utilization rate of the LTE network. FIG. 2 is a schematic diagram of a network with large-scale LTE network deployment according to the related art, and as shown in FIG. 2, with the large-scale deployment of the LTE network, the coverage of the LTE network will be greater than that of the HRPD network, at this moment, for the consideration of energy saving and so on, when there are few users of the HRPD network, the operators may wish to shut down the HRPD base stations and redirect the users of this HRPD base station into the LTE network; however, in such a situation, depending on the autonomous measurement and reselection mechanism of the terminal, the terminal may always select the HRPD network. In addition, when the load of the HRPD network is very heavy, the network may wish to be able to redirect a part thereof to the LTE system; alternatively, for certain application types of the terminal, such as video services which require high bandwidth, the network may wish to provide higher quality of service to it via the LTE network with high bandwidth. However, the existing mechanism which completely depends on the autonomous measurement and reselection of the terminal cannot meet the above-mentioned demand.

### SUMMARY

The main object of the present invention is to provide a solution for inter-system redirection, so as to at least solve the problem in the related art that a terminal in the HRPD network performs inter-system network reselection autonomously.

According to one aspect of the present invention, a method for inter-system redirection is provided, comprising: a base station sending a first message to a terminal, and instructing the terminal to perform redirection; the terminal accessing the redirected network; wherein the first message carries at least one of following: a type of wireless access technology, an identifier of whether to redirect, threshold information of redirection, recognition information of the redirected cell, carrier frequency information, return indication of redirection failure, grouping information of redirection.

Preferably, before the terminal accessing the redirected network, the method further comprises: the terminal launching measurement, and determining that the measurement result satisfies conditions of redirection.

Preferably, before the terminal launching measurement, the method further comprises: the base station sending the conditions of redirection to the terminal.

Preferably, before the base station sending the first message to the terminal, the method further comprises: the base station sending a second message to the terminal, and instructing the terminal to report the measurement result; the terminal returning a third message to the base station, wherein the third message carries the measurement result of the terminal; the base station determining that the terminal needs to perform redirection according to the measurement result; wherein the measurement result comprises at least one of following: recognition information of the cell, carrier frequency information, signal quality information, signal strength information.

Preferably, the base station determining that the terminal needs to perform redirection according to the measurement result comprises: the base station determining that the terminal needs to perform redirection according to the measurement result and operation status of the network.

Preferably, after the base station determining that the terminal needs to perform redirection according to the measurement result, the method further comprises: the base station selecting one or more redirection cells according to the measurement result, and notifying the terminal of the one or more redirection cells by the first message.

Preferably, the second message is one of following: other wireless access technology neighbor list message, routing update request message.

Preferably, the third message is one of following: measurement report message, routing update message.

Preferably, the first message is one of following: other wireless access technology neighbor list message, redirection message between different wireless access technologies, redirection message.

Preferably, the base station sending the first message to the terminal comprises: the base station sending the first message by broadcast or unicast.

According to another aspect of the present invention, a system for inter-system redirection is provided, comprising: a base station and a terminal, wherein the base station is configured to send a first message to the terminal and instructing the terminal to perform redirection; the terminal is configured to access the redirected network after receiving the first message.

According to yet another aspect of the present invention, a terminal is provided, comprising: a first receiving module, configured to receive a first message from a base station, wherein the first message is for instructing the terminal to perform redirection; an accessing module, configured to access the redirected network after receiving the first message, wherein the first message carries at least one of following: type of wireless access technology, an identifier of whether to redirect, threshold information of redirection, recognition information of the redirected cell, carrier frequency information, return indication of redirection failure, grouping information of redirection, wherein the terminal can support various modes.

Preferably, the terminal further comprises: a second receiving module, configured to receive a second message from the base station, wherein the second message is for instructing the terminal to report a measurement result; a sending module, configured to send a third message to the base station, wherein the third message carries the measurement result of the terminal; wherein the measurement result comprises at least one of following: recognition information of the cell, carrier frequency information, signal quality information, signal strength information.

By means of the present invention, the problem in the related art that a mobile terminal in the HRPD network performs inter-system network reselection on complete autonomy by way of a base station instructing the terminal to perform inter-system redirection, thus achieving the effects of reducing the network load, reducing the network operation cost, and ensuring the quality of service of the user to the greatest extent.

### BRIEF DESCRIPTION OF THE DRAWINGS

The drawings disclosed herein constitute a part of the application and provide for further understanding the present invention. The exemplary embodiments of the present invention and the description thereof are used to illustrate rather than limit the present invention. In the drawings:

FIG. 1 is a schematic diagram of a network at the initial stage of LTE network deployment according to the related art;

FIG. 2 is a schematic diagram of a network with large-scale LTE network deployment according to the related art;

FIG. 3 is a flowchart of a method for inter-system redirection according to an embodiment of the present invention;

FIG. 4 is a schematic diagram of a redirection method of network based solution with terminal assistance according to an embodiment of the present invention;

FIG. 5 is a schematic diagram of a redirection method of terminal based solution with network assistance according to an embodiment of the present invention;

FIG. 6 is a flowchart of a redirection method of network based solution with terminal assistance according to an embodiment of the present invention;

FIG. 7 is a flowchart of a redirection method of terminal based solution with network assistance according to an embodiment of the present invention; and

FIG. 8 is a structural block diagram of a system for inter-system redirection according to an embodiment of the present invention.

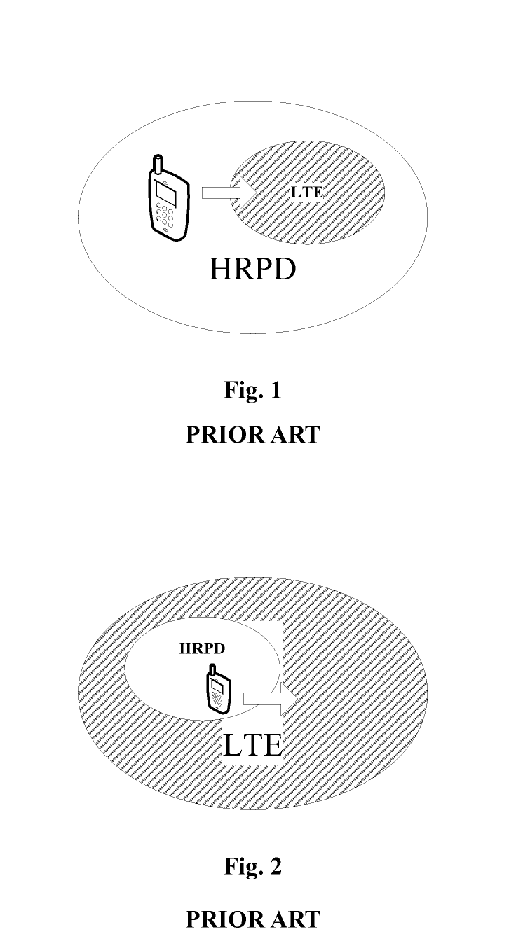

### DETAILED DESCRIPTION OF THE EMBODIMENTS

The present invention will be further illustrated hereinafter in conjunction with the drawings and the embodiments. It should be noted that in the application, the embodiments and the features in the embodiments can be combined with each other if no conflict occurs.

### METHOD EMBODIMENTS

An embodiment of the present invention provides a method for inter-system redirection, which method can be applied to the situation where the HRPD interoperates with other wireless access technologies, such as the situation where the HRPD interoperates with LTE.

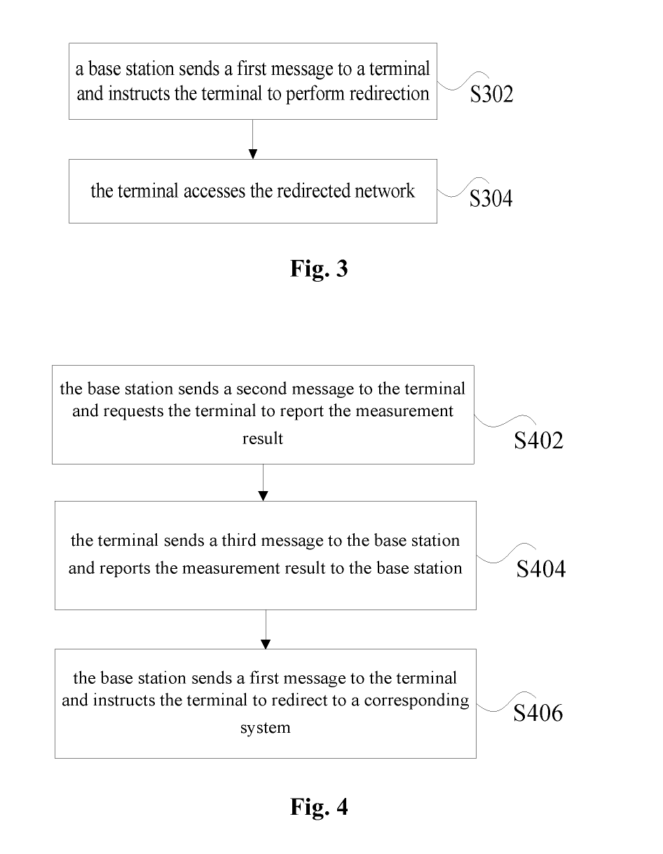

FIG. 3 is a flowchart of a method for inter-system redirection according to an embodiment of the present invention, and as shown in FIG. 3, the method comprises the following step S302 to step S304.

Step S302, a base station sends a first message to a terminal and instructs the terminal to perform redirection.

Step S304, the terminal accesses the redirected network.

In this embodiment, the base station instructs the terminal to perform redirection, which thus avoids a series of problems generated when the terminal performs inter-system network reselection autonomously, for example, when the load of the HRPD network is relatively high, the base station instructs the mobile terminal to perform redirection, so as to reduce the load of the network and ensure the quality of service of the user.

In a preferred implementation of an embodiment of the present invention, the terminal responds to the first message and launches measurement, and when it is determined that the measurement result satisfies conditions of redirection, the terminal accesses the redirected network. In this embodiment, the terminal judges whether to redirect according to the measurement result, thus being able to perform network redirection more stably.

Wherein, the base station sends the above-mentioned conditions of redirection to the terminal, for example, the base station sends a redirection message to the terminal by the first message.

In another preferred implementation of an embodiment of the present invention, before the base station sends the first message to the terminal, the following operation may be performed: the base station sends a second message to the terminal and instructs the terminal to report the measurement result; the terminal returns a third message to the base station, wherein the third message carries the measurement result of the terminal, which measurement result is the one the base station requests to report; the base station determines that the terminal needs to perform redirection according to the measurement result.

Preferably, the base station determining that the terminal needs to perform redirection according to the measurement result may comprise: the base station determining that the terminal needs to perform redirection according to the measurement result and operation status of the network, wherein the operation status of the network may be factors such as network load, type of service provided to the terminal and so on.

Preferably, after the base station determines that the terminal needs to perform redirection according to the measurement result, the base station selects one or more redirection cells according to the measurement result, and notifies the terminal of the one or more redirection cells by the first message for the terminal to perform redirection.

Wherein, the second message may be other wireless access technology neighbor list message or routing update request message.

Wherein, the third message may be measurement report message or routing update message.

Wherein, the measurement result may comprise at least one of following: recognition information of the cell, carrier frequency information, signal quality information, signal strength information.

Preferably, the first message may be one of following: other wireless access technology neighbor list message, redirection message between different wireless access technologies, redirection message.

Preferably, the first message may carry at least one of following: type of wireless access technology, an identifier of whether to redirect, threshold information of redirection, recognition information of the redirected cell, carrier frequency information, return indication of redirection failure, grouping information of redirection.

Wherein, the base station sending the first message to the terminal comprises: the base station sending the first message to the terminal by broadcast or unicast.

### Method Embodiment 1

According to an embodiment of the present invention, a redirection method of network based solution with terminal assistance is provided. FIG. 4 is a flowchart of a redirection method according to an embodiment of the present invention, and as shown in FIG. 4, the method comprises the following step S402 to step S406.

Step S402, the base station sends a second message to the terminal, wherein the terminal carries instruction information for enabling the terminal to report the measurement result.

Step S404, the terminal sends a third message to the base station, wherein the third message carries measurement result information.

Step S406, the base station sends a first message to the terminal, wherein the first message carries information for redirection.

Then, the terminal can perform redirection.

### Method Embodiment 2

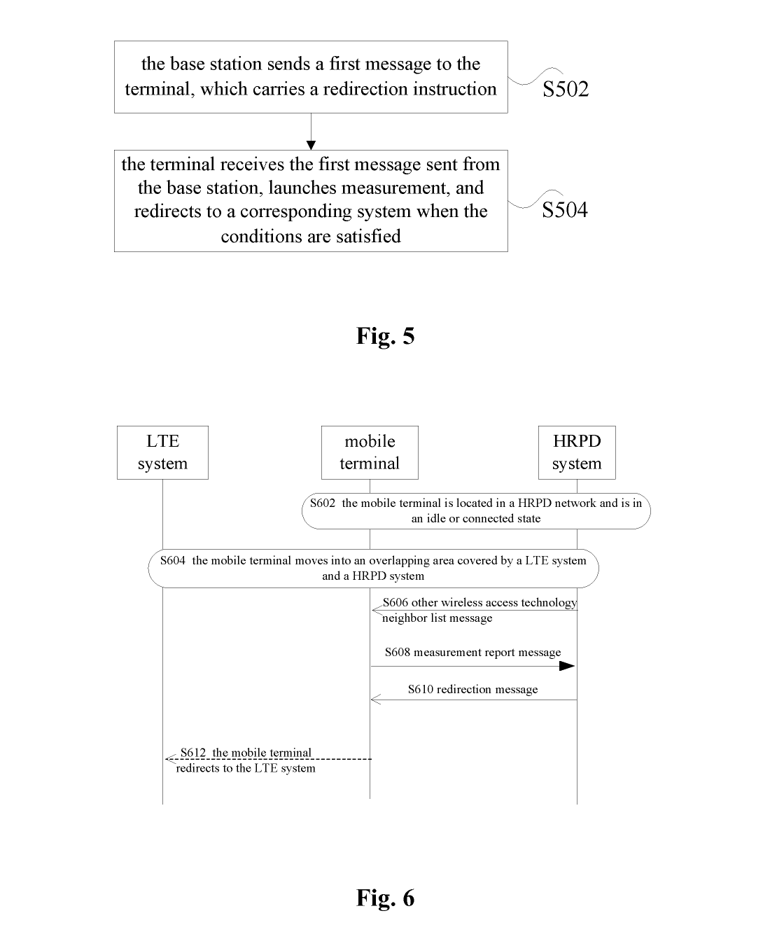

According to an embodiment of the present invention, a redirection method of terminal based solution with network assistance, and FIG. 5 is a flowchart of a redirection method according to an embodiment of the present invention, and as shown in FIG. 5, the method comprises the following step S502 to step S504.

Step S502, the base station sends a first message to the terminal, wherein the first message carries redirection system information for enabling the terminal to perform redirection.

Step S504, the terminal receives the first message sent from the base station and launches measurement, and if the measurement result satisfies the redirection threshold required by the base station, the terminal accesses the corresponding system (i.e., redirected network).

### Example 1

In this embodiment, taking a HRPD system instructing a terminal to redirect to an LTE system as an example for description, it should be noted that this embodiment is not limited to such, and the content and implementation contained in this embodiment can also be applied to the demand that the HRPD system instructs the terminal to redirect to the systems of other wireless access technologies.

FIG. 6 is a flowchart of a redirection method of network based solution with terminal assistance based on HRPD system according to method embodiment 1 of the present invention, and as shown in FIG. 6, the flow comprises the following step S602 to step S612.

Step S602, a mobile terminal is located in a HRPD system and is in an idle or connected state.

Step S604, the mobile terminal moves into an overlapping area covered by the HRPD system and an LTE system.

Step S606, the HRPD system wishes to redirect the terminal according to information such as the current system load or the service type of terminal and so on. The base station sends an other wireless access technology neighbor list message to the terminal, which message includes instruction information about requiring the terminal to report the measurement result and also includes information about the network which is expected to be measured by the terminal, such as carrier frequency information, threshold information and so on. It needs to be noted that in this step, the base station may also send other messages carrying the same content to the terminal, such as routing update request message.

Step S608, after receiving the message which includes an instruction to report the measurement result, the terminal launches measurement and reports the measurement result to the base station; the measurement result includes at least one of the following: sector information, carrier frequency information, signal strength information, signal quality information and so on.

Step S610, after receiving the message reported by the terminal and including the measurement result, the base station summarizes one of the following or a combination thereof: information such as signal strength, signal quality, sector load, terminal service type and so on, and selects a redirection target sector, and if the terminal reports a plurality of sectors, the base station ranks these sectors according to priority and sends the selected redirection target sector to the terminal by a message for direction.

Step S612, the terminal redirects to the LTE system. If the terminal is in a connected state, optionally, before redirecting to the LTE system, it may send a release message to the HRPD system first, i.e., before accessing the redirected network (LTE network), the terminal can send a release message to the current base station first.

### Example 2

In this embodiment, taking a HRPD system instructing a terminal to redirect to an LTE system as an example for description, it should be noted that this embodiment is not limited to such, and the content and implementation contained in this embodiment can also be applied to the demand that the HRPD system instructs the terminal to redirect to the systems of other wireless access technologies.

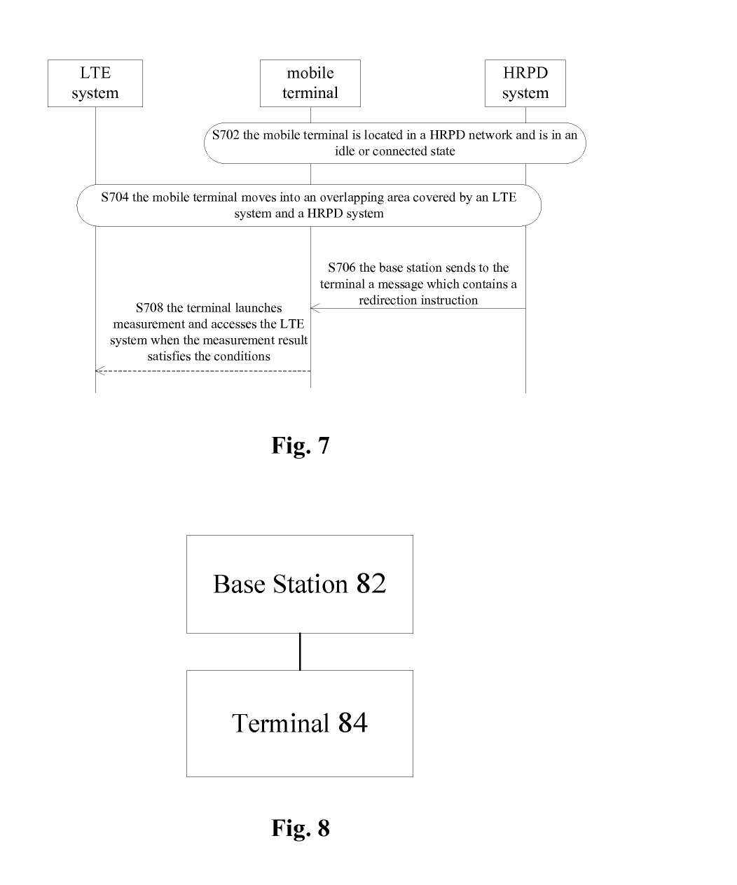

FIG. 7 is a flowchart of a redirection method of terminal based solution with network assistance based on HRPD system according to method embodiment 2 of the present invention, and as shown in FIG. 7, the flow comprises the following step S702 to step S708.

Step S702, a mobile terminal is located in a HRPD system and is in an idle or connected state.

Step S704, the mobile terminal moves into an overlapping area covered by the HRPD system and an LTE system.

Step S706, the HRPD system wishes to redirect the terminal according to information such as the current system load or the service type of terminal and so on. The base station sends an other wireless access technology neighbor list message to the terminal, which message includes instruction information about requiring the terminal to report the measurement result and also includes information about the network which is expected to be measured by the terminal, such as carrier frequency information, threshold information and so on. It needs to be noted that in this step, the base station may also send other messages carrying the same content to the terminal, such as routing update request message.

Step S708, after receiving the message which includes redirection instruction, the terminal launches measurement, and if the measurement result satisfies the redirection threshold required by the base station (i.e., conditions of redirection), the terminal accesses the redirected network. If the terminal is in a connected state, optionally, before redirecting to the LTE system, it may send a release message to the HRPD system first, i.e., before accessing the redirected network (LTE network), the terminal can send a release message to the current base station first.

System Embodiments

An embodiment of the present invention provides a system for inter-system redirection, which system is applied to implement the above-mentioned method.

FIG. 8 is a structural block diagram of a system for inter-system redirection according to an embodiment of the present invention, and as shown in FIG. 8, the system comprises: a base station 82 and a terminal 84, wherein the base station 82 is configured to send a first message to the terminal and instruct the terminal to perform redirection; the terminal 84 is coupled to the base station 82 and configured to access the redirected network after receiving the first message.

In a preferred example of an embodiment of the present invention, the terminal 84 is also configured to, before accessing the redirected network, start to measure and determine that the measurement result satisfies conditions of redirection.

Preferably, the base station 82 is configured to send the above-mentioned conditions of redirection to the terminal 84.

In another preferred example of an embodiment of the present invention, the base station 82 is configured to send a second message to the terminal 84 and instruct the terminal 84 to report the measurement result; the terminal 84 is configured to return a third message to the base station 82, wherein the third message carries the measurement result of the terminal 84; the base station 82 is configured to determine that the terminal 84 needs to perform redirection according to the measurement result; then the base station 82 sends a first message to the terminal.

Preferably, the base station 82 is also configured to determine that the terminal 84 needs to perform redirection according to the measurement result and the operation status of the network, wherein the operation status of the network may be factors such as network load, type of service provided to the terminal and so on.

Preferably, after determining that the terminal 84 needs to perform redirection according to the measurement result, the base station 82 is further configured to select one or more redirection cells according to the measurement result, and notify the terminal 84 of the one or more redirection cells by the first message.

Wherein, the second message may be other wireless access technology neighbor list message or routing update request message.

Wherein, the third message may be measurement report message or routing update message.

The measurement result may comprise at least one of following: recognition information of the cell, carrier frequency information, signal quality information, signal strength information.

Preferably, the first message may be one of following: other wireless access technology neighbor list message, redirection message between different wireless access technologies, redirection message.

Preferably, the first message may carry at least one of following: type of wireless access technology, an identifier of whether to redirect, threshold information of redirection, recognition information of the redirected cell, carrier frequency information, return indication of redirection failure, grouping information of redirection.

The base station 82 is also configured to send the first message to the terminal 84 by broadcast or unicast.

In another preferred example of an embodiment of the present invention, a terminal is also provided, which terminal can realize the functions of the terminal 84. The terminal can support various modes. The terminal comprises: a first receiving module, configured to receive a first message from a base station, wherein the first message is for instructing the terminal to perform redirection; an accessing module, configured to access the redirected network after receiving the first message, wherein the first message carries at least one of following: type of wireless access technology, an identifier of whether to redirect, threshold information of redirection, recognition information of the redirected cell, carrier frequency information, return indication of redirection failure, grouping information of redirection, wherein the terminal can support various modes.

Preferably, the terminal further comprises: a second receiving module, configured to receive a second message from the base station, wherein the second message is for instructing the terminal to report a measurement result; a sending module, configured to send a third message to the base station, wherein the third message carries the measurement result of the terminal; wherein the measurement result comprises at least one of following: recognition information of the cell, carrier frequency information, signal quality information, signal strength information.

In summary, by way of the above-mentioned embodiments of the present invention, the HRPD network can redirect some mobile terminals in the network to other networks, which on one hand reduces the network load and on the other hand, for certain types of services, allows the terminal to enjoy a higher quality of service in other wireless access technology networks.

It is obvious for the person skilled in this art that, the modules or steps of the present invention above can be also realized by a general computer device. They can be integrated in a single computer device or distributed on the network composed of several computer devices, or alternatively achieved by executable codes of a computer device, so as to store them in a storage unit for execution by a computer device, or make them into different integrated circuit modules or make multiple modules or steps of them to a single integrated circuit module for realization of the present invention. In this way, the present invention is not restricted to the combination of any specific hardware and software.

The description above is just the preferred embodiments of the present invention, and is not intended to limit the present invention. For the person skilled in this art, the present invention can have various alterations and changes. Any such change, equivalent substitution or improvement made within the principle of the present invention should be covered in the protection scope of the present invention.

1. A method for a terminal in a connected state redirecting from a high rate packet data (HRPD) system to a different system, comprising:
a HRPD base station sending a first message to the terminal, and instructing the terminal to perform redirection;
the terminal accessing the redirected network;
wherein,
before the terminal accessing the redirected network, the method further comprises:
the HRPD base station sending a second message to the terminal, and instructing the terminal to report the measurement result;
the terminal returning a third message to the HRPD base station, wherein the third message carries the measurement result of the terminal;
wherein the measurement result comprises at least one of following: recognition information of the cell, carrier frequency information, signal quality information, signal strength information,
before the HRPD base station sending the first message to the terminal, the method further comprises:
if the HRPD base station receives the measurement result reported by the terminal, the HRPD base station determining that the terminal needs to perform redirection according to the measurement result,
the first message carries at least one of following: a type of wireless access technology, threshold information of redirection, recognition information of the redirected cell, carrier frequency information.

2.-4. (canceled)

5. The method according to claim 1, wherein the HRPD base station determining that the terminal needs to perform redirection according to the measurement result comprises:
the HRPD base station determining that the terminal needs to perform redirection according to the measurement result and operation status of the network.

6. The method according to claim 1, wherein after the HRPD base station determining that the terminal needs to perform redirection according to the measurement result, the method further comprises:
the HRPD base station selecting one or more redirection cells according to the measurement result, and notifying the terminal of the one or more redirection cells by the first message.

7. (canceled)

8. The method according to claim 1, wherein the third message is a measurement report message.

9. The method according to claim 1, wherein the first message is one of following:
other wireless access technology neighbor list message, redirection message between different wireless access technologies.

10. The method according to claim 1, wherein the base station sending the first message to the terminal comprises:
the base station sending the first message by unicast.

11. A system for a terminal in a connected state redirecting from a high rate packet data (HRPD) system to a different system, comprising: a HRPD base station and a terminal,
the HRPD base station, configured to send a first message to the terminal and instruct the terminal to perform redirection;
the terminal, configured to access the redirected network after receiving the first message;
wherein,
the HRPD base station is further configured to send a second message to the terminal and instruct the terminal to report the measurement result;
the terminal is further configured to return a third message to the HRPD base station, wherein the third message carries the measurement result of the terminal, wherein the measurement result comprises at least one of following: recognition information of the cell, carrier frequency information, signal quality information, signal strength information,
if the HRPD base station receives the measurement result reported by the terminal, the HRPD base station is further configured to determine that the terminal needs to perform redirection according to the measurement result,
the first message carries at least one of following: type of wireless access technology, threshold information of redirection, recognition information of the redirected cell, carrier frequency information.

12. A terminal, comprising a hardware processor configured to:
receive a first message from a base station, wherein the first message is for instructing the terminal to perform redirection;
access the redirected network after receiving the first message, wherein the first message carries at least one of following: type of wireless access technology, an identifier of whether to redirect, threshold information of redirection, recognition information of the redirected cell, carrier frequency information
receive a second message from the base station, wherein the second message is for instructing the terminal to report a measurement result;
send a third message to the base station, wherein the third message carries the measurement result of the terminal;
wherein the measurement result comprises at least one of following: recognition information of the cell, carrier frequency information, signal quality information, signal strength information.

13. (canceled)

14. The method according to claim 5, wherein the third message is a measurement report message.

15. The method according to claim 6, wherein the third message is a measurement report message.

16. The method according to claim 2, wherein the first message is one of following:
other wireless access technology neighbor list message, redirection message between different wireless access technologies.

17. The method according to claim 3, wherein the first message is one of following:
other wireless access technology neighbor list message, redirection message between different wireless access technologies.

18. The method according to claim 4, wherein the first message is one of following:
other wireless access technology neighbor list message, redirection message between different wireless access technologies.

19. The method according to claim 5, wherein the first message is one of following:
other wireless access technology neighbor list message, redirection message between different wireless access technologies.

20. The method according to claim 6, wherein the first message is one of following:
other wireless access technology neighbor list message, redirection message between different wireless access technologies.
